(19) United States
(12) Patent Application Publication
(10) Pub. No.: US 2004/0125971 A1
(43) Pub. Date: Jul. 1, 2004

(54) Combination loudspeaker unit

(75) Inventor: Mark Dodd, Woodbridge (GB)

Correspondence Address: MYERS DAWES ANDRAS & SHERMAN, 11th Floor, 19900 MacArthur Blvd., Irvine, CA, 92612, US

(73) Assignee: KH Technology Corporation

(21) Appl. No.: 10/641,616

(22) Filed: Aug. 15, 2003

(30) Foreign Application Priority Data
Aug. 17, 2002 (GB) 0219245.8

(51) Int. Cl. H04R 5/02

(52) U.S. Cl. 381/310

(57) ABSTRACT

A loudspeaker unit has, in combination, a pistonically driven diaphragm loudspeaker and a generally planar resonant panel loudspeaker, in which the plane of the resonant panel lies in the same orientation as an axis along which the diaphragm is pistonically driven. The resonant panel loudspeaker may be located behind the diaphragm loudspeaker, with the resonant panel loudspeaker functioning as a diffuse dipole, e.g. to generate surround sound reproduction, and the diaphragm loudspeaker located in the null of the dipole and functioning as an acoustic monopole, e.g. to generate imaged stereophonic sound reproduction.

### FIELD OF THE INVENTION

The present invention relates to loudspeaker units, and particularly for use in “home cinema” applications.

### BACKGROUND OF THE INVENTION

A crucial aspect of home cinema systems is the nature and quality of the sound reproduction. An important feature of good home cinema sound reproduction is so-called “surround sound”, i.e. the illusion that the reproduced sound is emanating from all around the listener rather than from specific discrete sources (i.e. the surround sound loudspeakers). Conventionally, surround sound loudspeakers are located behind and/or to the side of the viewer and generally comprise two pistonic diaphragm drivers operating out of phase in order to produce a “figure-of-eight” dipole acoustic radiation directivity characteristic (the drivers may be in phase at base frequencies, or there may be a separate low frequency driver in the enclosure). However, such conventional pistonic surround sound loudspeakers suffer from the disadvantages that they tend to be expensive, and generally do not produce an entirely convincing ambient sound profile for the listener.

### BRIEF SUMMARY OF THE INVENTION

The present invention seeks to provide a new type of loudspeaker unit suitable for five channel super audio compact disc (SACD) and/or suitable for creating surround sound reproduction, for example for home cinema applications. The present invention particularly seeks to avoid the need for separate surround sound loudspeakers located behind the viewer of a home cinema system. However, the present invention is not limited to SACD or home cinema applications, or to surround sound in general, although such applications will be particularly suited to the present invention.

Accordingly, a first aspect of the present invention provides a loudspeaker unit comprising, in combination, a pistonically driven diaphragm loudspeaker and a generally planar resonant panel loudspeaker, wherein the plane of the resonant panel lies generally in the same orientation as an axis along which the diaphragm is pistonically driven (i.e., a loudspeaker in which a diaphragm moves in a piston-like motion as a generally rigid whole for at least part of its operating frequency range).

The plane of the resonant panel loudspeaker may, for example, be generally parallel to the axis along which the diaphragm is pistonically driven. Preferably, however, the plane of the resonant panel and the axis are generally in line with each other (i.e. the axis preferably lies in generally the same plane as the panel). Preferably the plane of the panel lies substantially in the same orientation as the axis along which the diaphragm is pistonically driven. Consequently the panel and the axis preferably are either substantially parallel to each other or substantially in line with each other (i.e. the axis preferably lies in substantially the same plane as the panel).

Preferably the resonant panel loudspeaker is located relative to the pistonically driven diaphragm loudspeaker (hereinafter the “diaphragm loudspeaker”) such that the emission of the acoustic radiation from the diaphragm loudspeaker is substantially unimpeded by the resonant panel loudspeaker. Advantageously, the resonant panel may be located above, below, to the side, or behind the diaphragm loudspeaker. Most preferably the panel is located behind the diaphragm loudspeaker.

Preferably the resonant panel loudspeaker is arranged to radiate sound from both opposite major surfaces of the panel simultaneously.

The present invention has the advantage that by orientating the plane of the resonant panel loudspeaker so that it is in generally the same orientation as the axis of the pistonically driven diaphragm loudspeaker the resonant panel loudspeaker normally produces a generally “figure-of-eight” acoustic radiation pattern by radiating sound from both opposite major surfaces of the panel with the “null” of the radiation pattern generally coincident with the axis of the diaphragm loudspeaker. Consequently, the use of a resonant panel loudspeaker in this orientation produces the type of acoustic radiation pattern generally required of surround sound. Additionally, and most advantageously, resonant panel loudspeakers tend to produce diffuse acoustic radiation, which is ideal for surround sound. These two characteristics in combination mean that the resonant panel loudspeaker of the loudspeaker unit according to the present invention generally provides an extremely effective surround sound loudspeaker system. The fact that the loudspeaker unit according to the present invention combines such a surround sound loudspeaker with a diaphragm loudspeaker (which preferably operates as a monopole) has the tremendous advantage that separate surround sound loudspeakers situated behind the viewer/listener can be dispensed with, and instead one or more (preferably a pair) of loudspeaker units according to the present invention situated adjacent to (or as part on the television (or other home cinema screen) will provide both imaged sound and surround sound.

A second aspect of the present invention provides the use of a loudspeaker unit according to the first aspect of the present invention, to provide both surround sound reproduction and imaged stereophonic sound reproduction simultaneously. The resonant panel loudspeaker preferably provides the surround sound reproduction and the pistonically driven diaphragm loudspeaker preferably provides the imaged stereophonic sound reproduction.

A third aspect of the present invention provides an audio-visual system comprising a visual display means and at least one (but preferably two) loudspeaker unit(s) according to the first aspect of the present invention. Preferably the audio-visual system is a home cinema (or home entertainment) system. Preferably the visual display means comprises a television set. The visual display means and the loudspeaker unit(s) may be combined in a single unit.

Other preferred and optional features of the present invention are described below.

### BRIEF DESCRIPTION OF THE DRAWINGS

These and other features, aspects and advantages of the present invention will become understood with reference to the following description, appended claims and accompanying figures where:

FIG. 1 is a schematic illustration of the relative positions and orientations of a resonant panel loudspeaker and a diaphragm loudspeaker of an embodiment of a loudspeaker unit according to the present invention;

FIG. 2 is a schematic illustration of an audio-visual system according to the present invention in use; and

FIG. 3 is an exploded diagram of a preferred embodiment of a loudspeaker unit according to the present invention.

### DETAILED DESCRIPTION OF THE INVENTION

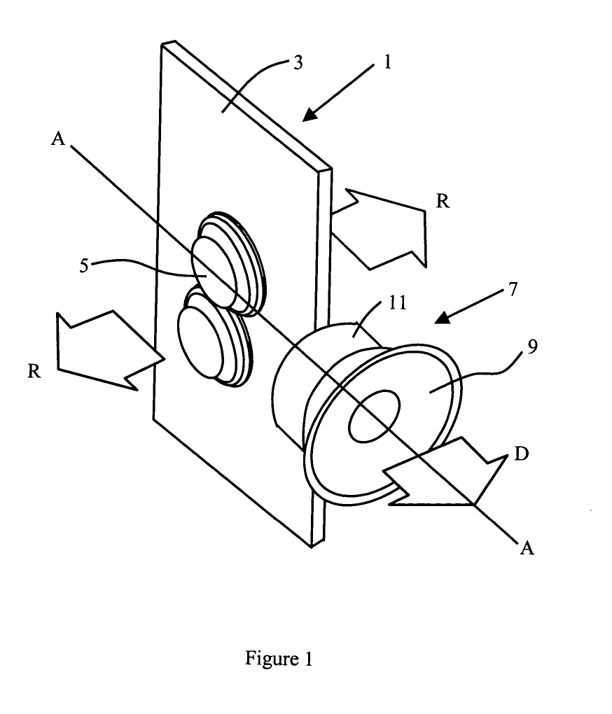

FIG. 1 shows, schematically, a loudspeaker unit 10 according to an embodiment of the present invention, comprising a resonant panel loudspeaker 1 and a diaphragm loudspeaker 7. The example resonant panel loudspeaker 1 comprises a generally planar resonant panel 3 having exciters 5 attached thereto. The exciters 5 (two of which are shown, but the panel 3 may have just one exciter 5 or more than two exciters) are the drivers of the resonant panel loudspeaker 1, and cause the panel 3 to resonate and thereby to emit acoustic radiation.

The exciter(s) 5 may generally comprise any type of transducer, for example electromagnetic (e.g. moving coil), piezoelectric, or electrostatic. The panel 3 itself may be formed from any of a wide variety of materials, for example polymeric materials and/or glass fibre materials and/or carbon fibre materials and/or cardboard (or the like). The panel 3 may comprise a single sheet of material, a plurality of layers (or other composite construction) and/or may include a core, for example of honeycomb or foam construction.

In this example, the panel 3 is substantially planar (i.e. a generally thin and flat panel). This has the advantage that the acoustic radiation patterns which emanate from each major surface of the panel 3 may be substantially the same as each other (thereby, for example, enhancing the diffuse surround sound nature of the sound reproduction).

Resonant panel loudspeakers are often termed “distributed-mode” loudspeakers (DMLs) because they generally function by exciting a plurality of vibrational modes distributed throughout the panel (the panel generally operating wholly in resonance). The resonant panel loudspeaker may, for example, be substantially as described in international patent application no. PCT/GB96/02145, the entire disclosure of which is incorporated herein by reference.

Referring to the pistonically driven diaphragm loudspeaker 7, the terms “pistonic loudspeaker” and “pistonically driven diaphragm loudspeaker” in this specification refer to a loudspeaker in which a diaphragm moves in a piston-like motion as a generally rigid whole for at least part of its operating frequency range (for example up to approximately 700 Hz). As such, the example pistonically driven diaphragm loudspeaker 7 comprises a generally conical diaphragm 9 and a driver 11 for the diaphragm 9. The driver 11 can be an electro-mechanical transducer, e.g. a moving coil transducer, but other types of drivers can also be used.

The pistonically driven diaphragm loudspeaker 7 preferably provides imaged sound reproduction (whereas the resonant panel loudspeaker 1 preferably provides diffuse surround sound reproduction). Most preferably, the diaphragm loudspeaker 7 functions as a monopole acoustic source (and preferably the resonant panel loudspeaker 1 functions as a diffuse dipole acoustic source). The diaphragm loudspeaker 7 preferably emits the acoustic output of the left/right signal of the stereophonic source.

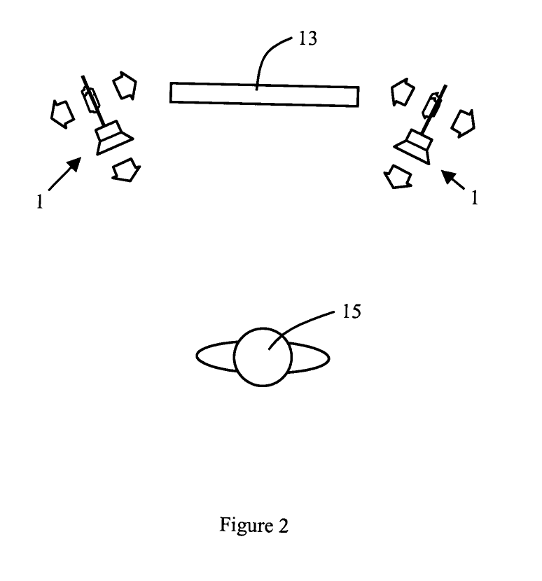

Therefore, as shown by example in FIG. 2 and described further below, in use two loudspeaker units 10 according to the present invention are used by a listener (or viewer of a home cinema system), with each of the two diaphragm loudspeakers 7 of the two units 10 emitting imaged stereophonic acoustic radiation and the two resonant panel loudspeakers 1 emitting diffuse (non-imaged) surround sound acoustic radiation.

The plane of the resonant panel loudspeaker 1 may, for example, be generally parallel to the axis along which the diaphragm 9 is pistonically driven. Preferably, however, the plane of the resonant panel 3 and said axis are generally in line with each other (i.e. the axis preferably lies in generally the same plane as the panel). Preferably the plane of the panel 3 lies substantially in the same orientation as the axis along which the diaphragm 9 is pistonically driven. Consequently, the panel 3 and the axis preferably are either substantially parallel to each other or substantially in line with each other (i.e. the axis preferably lies in substantially the same plane as the panel).

As shown by example in FIG. 1, the plane of the resonant panel 3 lies in the same orientation as the axis A-A along which the diaphragm 9 is pistonically driven. In fact, the axis A-A lies in the same plane as the resonant panel 3. Preferably, the resonant panel loudspeaker 1 is located relative to the pistonically driven diaphragm loudspeaker 7 such that the emission of the acoustic radiation from the diaphragm loudspeaker 7 is substantially unimpeded by the resonant panel loudspeaker 1. Advantageously, the resonant panel loudspeaker 1 may be located above, below, to the side, or behind the diaphragm loudspeaker 7. Most preferably the resonant panel speaker 1 is located behind the diaphragm loudspeaker 7. As such, in FIG. 1, the resonant panel 3 is located to the rear of the diaphragm loudspeaker 7, so that the directional acoustic output (as indicated by arrow D) of the diaphragm loudspeaker 7 is unimpeded by the resonant panel loudspeaker 1.

The acoustic output of the resonant panel loudspeaker 1 is indicated by arrows R. As can be seen, the output of the resonant panel 3 is generally perpendicular to that of the diaphragm 9. However, the output of the resonant panel 3 is diffuse and in the form of dipole with the “null” centred on the axis A-A of the diaphragm loudspeaker 7. Consequently, the null of the diffuse dipole of the resonant panel loudspeaker 1 will generally be centred on the listener/viewer, if the diaphragm loudspeaker 7 is directed towards the listener/viewer, and the output of the resonant panel 3 will be perceived as ambient surround sound despite the fact that loudspeaker units will normally be located only in front of the listener/viewer.

Preferably the resonant panel loudspeaker 1 is arranged to radiate sound from both opposite major surfaces of the panel 3 simultaneously. A loudspeaker unit 10 according to the present invention has the advantage that by orientating the plane of the resonant panel loudspeaker 1 so that it is in generally the same orientation as the axis of the pistonically driven diaphragm loudspeaker 7 the resonant panel loudspeaker 1 normally produces a generally “figure-of-eight” acoustic radiation pattern by radiating sound from both opposite major surfaces of the panel 3 with the “null” of the radiation pattern generally coincident with the axis of the diaphragm 9 loudspeaker 7. Consequently, the use of a resonant panel loudspeaker 1 in this orientation produces the type of acoustic radiation pattern generally required of surround sound. Additionally, and most advantageously, resonant panel loudspeakers tend to produce diffuse acoustic radiation, which is ideal for surround sound. These two characteristics in combination mean that the resonant panel loudspeaker 1 of the loudspeaker unit 10 according to the present invention generally provides an extremely effective surround sound loudspeaker system. The fact that the loudspeaker unit 10 according to the present invention combines such a surround sound loudspeaker 1 with a diaphragm loudspeaker 7 (which preferably operates as a monopole) has the tremendous advantage that separate conventional surround sound loudspeakers situated behind the viewer/listener can be dispensed with, and instead one or more (preferably a pair) of loudspeaker units 10 according to the present invention situated adjacent to (or as part of) the television (or other home cinema screen) will provide both imaged sound and surround sound, as described further below in relation to FIG. 2.

FIG. 2 is a schematic plan view of an example home cinema system 12 according to the present invention. The system 12 comprises a television set 13 (or other visual display means) and two loudspeaker units according to the present invention, such as the loudspeaker units 10 shown in FIG. 1. The loudspeaker units 10 are located on either side of the television 13 and orientated such that their diaphragm loudspeakers 7 are directed towards the listener/viewer 15. As described above, this arrangement creates the perception of ambient surround sound for the viewer/listener, despite the loudspeakers 10 being situated only in front (and not to the rear or side) of the viewer/listener. The arrangement also creates imaged stereophonic sound, due to the directional monopole diaphragm loudspeakers.

Each loudspeaker unit 10 may comprise more than one pistonically driven diaphragm loudspeaker 7 and/or more than one resonant panel loudspeaker 1. For example, the function of the pistonic loudspeaker 7 may be carried out by a plurality of pistonic loudspeakers (e.g. with each such loudspeaker dedicated to a respective frequency range). The pistonically driven diaphragm loudspeaker 7 may, for example, comprise a compound loudspeaker of the type disclosed in U.S. Pat. No. 5,548,657, the entire disclosure of which is incorporated herein by reference.

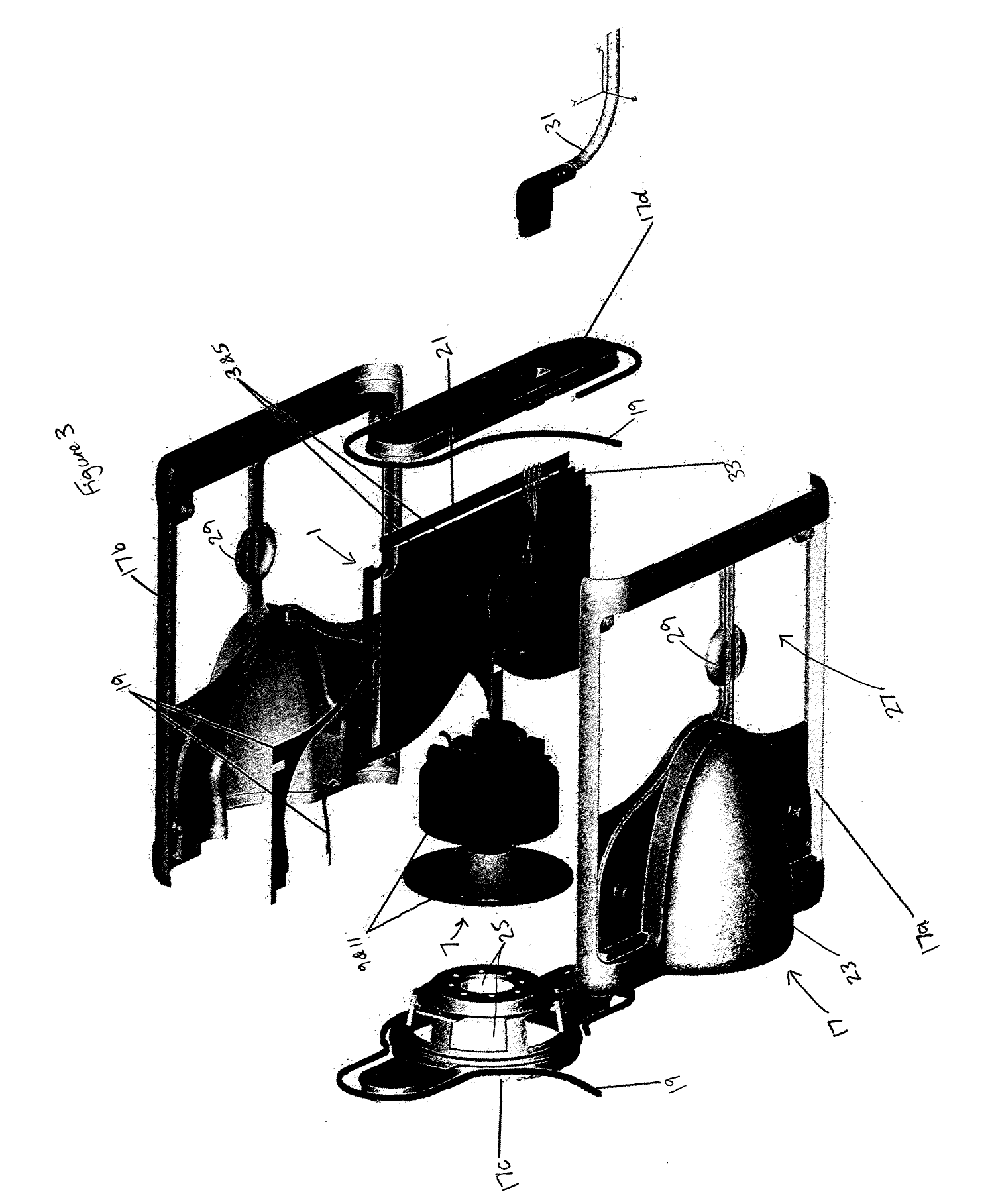

An enclosure for the loudspeaker unit 10 is omitted from FIG. 1 for clarity. Preferably, a loudspeaker unit 10 according to the present invention, further comprises an enclosure in which the resonant panel loudspeaker 1 and the diaphragm loudspeaker 7 are housed. FIG. 3 is an exploded diagram of a preferred embodiment of a loudspeaker unit 14 according to the present invention. In this embodiment, the loudspeaker unit 14 comprises a resonant panel loudspeaker 1 comprising a resonant panel 3 with an exciter 5 (in the form of an electro-mechanical transducer) attached thereto, and a pistonically driven diaphragm loudspeaker 7. The diaphragm loudspeaker 7 comprises a diaphragm 9 and a driver 11. The example pistonically driven diaphragm loudspeaker 7 illustrated in FIG. 3 can be a compound loudspeaker of the type disclosed in U.S. Pat. No. 5,548,657. The compound diaphragm loudspeaker 7 comprises a low frequency part having the generally conical diaphragm 9 shown, and a high frequency part having a generally dome-shaped diaphragm (not shown) located in or adjacent to the neck of the conical diaphragm 9.

The loudspeaker unit 14 shown in FIG. 3 also includes an enclosure 17 in which the resonant panel loudspeaker 1 and the diaphragm loudspeaker 7 are housed. The enclosure 17 comprises a plurality of sections, or panels, assembled together around the loudspeakers 1 and 7. In the example shown, the enclosure 17 comprises two side panels 17a and 17b, a front panel 17c, and a rear panel 17d. The various panels have gaskets (or other seals) 19 situated between them, to seal the enclosure. The gaskets (or other seals) 19 may, for example, be formed from polymeric foam or other polymeric sealing material. The resonant panel 3 is retained in place in the enclosure 17 by means of an adhesive pad 21 (and/or by means of adhesive tape, not shown).

As can clearly be seen in FIG. 3, the enclosure 17 comprises two main parts. A first part 23 of the enclosure 17 encloses (preferably fully encloses) the pistonically driven diaphragm loudspeaker 7 other than by the front panel 17c that includes openings 25 through which the forwardly-directed acoustic radiation emitted by the diaphragm loudspeaker 7 is arranged to propagate. A second part 27 retains the resonant panel loudspeaker 1 but is open on opposite major sides thereof adjacent to the opposite major sides of the resonant panel 3, to allow the sidewardly directed acoustic radiation emitted by the resonant panel loudspeaker 1 to propagate substantially freely from the unit. The (or each) exciter 5 is protected by means of small enclosure elements 29 located within the open sides of the second part 27 of the enclosure. A lead 31 is connectable to both loudspeakers 1, 7 of the unit 14 via terminal pins 33.

As such, the present invention provides a novel loudspeaker unit suitable for e.g. five channel super audio compact disc (SACD) and/or suitable for creating surround sound reproduction, for example for home cinema applications. The present invention particularly avoids the need for separate surround sound loudspeakers located behind the viewer of a home cinema system. However, the present invention is not limited (at least in its broadest aspects) to SACD or home cinema applications, or to surround sound in general, although such applications will be particularly suited to the present invention.

The present invention has been described in considerable detail with reference to certain preferred versions thereof; however, other versions are possible. Therefore, the spirit and scope of the appended claims should not be limited to the description of the preferred versions contained herein.

What is claimed is:

1. A loudspeaker unit comprising, in combination, a pistonically driven diaphragm loudspeaker having a diaphragm, and a generally planar resonant panel loudspeaker, wherein the plane of the resonant panel loudspeaker lies generally in the same orientation as an axis along which the diaphragm is pistonically driven.

2. A loudspeaker unit according to claim 1, in which the plane of the resonant panel loudspeaker lies substantially in the same orientation as an axis along which the diaphragm is pistonically driven.

3. A loudspeaker unit according to claim 2, in which the axis along which the diaphragm is pistonically driven lies substantially in, or is substantially parallel to, the plane of the resonant panel loudspeaker.

4. A loudspeaker unit according to claim 1, in which the resonant panel loudspeaker is located relative to the pistonically driven diaphragm loudspeaker such that emission of acoustic radiation from the diaphragm loudspeaker is substantially unimpeded by the resonant panel loudspeaker.

5. A loudspeaker unit according to claim 2, in which the resonant panel loudspeaker is located relative to the pistonically driven diaphragm loudspeaker such that emission of acoustic radiation from the diaphragm loudspeaker is substantially unimpeded by the resonant panel loudspeaker.

6. A loudspeaker unit according to claim 3, in which the resonant panel loudspeaker is located relative to the pistonically driven diaphragm loudspeaker such that emission of acoustic radiation from the diaphragm loudspeaker is substantially unimpeded by the resonant panel loudspeaker.

7. A loudspeaker unit according to claim 1, in which the resonant panel loudspeaker is located above the diaphragm loudspeaker.

8. A loudspeaker unit according to claim 1, in which the resonant panel loudspeaker is located below the diaphragm loudspeaker.

9. A loudspeaker unit according to claim 1, in which the resonant panel loudspeaker is located to a side of the diaphragm loudspeaker.

10. A loudspeaker unit according to claim 1, in which the resonant panel loudspeaker is located behind the diaphragm loudspeaker.

11. A loudspeaker unit according to claim 1, in which the resonant panel loudspeaker includes a panel comprising two opposite major surfaces, and the resonant panel loudspeaker is arranged to radiate sound from both opposite major surfaces of the panel simultaneously.

12. A loudspeaker unit according to claim 2, in which the resonant panel loudspeaker includes a panel comprising two opposite major surfaces, and the resonant panel loudspeaker is arranged to radiate sound from both opposite major surfaces of the panel simultaneously.

13. A loudspeaker unit according to claim 4, in which the resonant panel loudspeaker includes a panel comprising two opposite major surfaces, and the resonant panel loudspeaker is arranged to radiate sound from both opposite major surfaces of the panel simultaneously.

14. A loudspeaker unit according to claim 1, in which the resonant panel loudspeaker comprises a resonant panel and one or more exciters arranged to excite the panel.

15. A loudspeaker unit according to claim 14, in which each exciter comprises a transducer.

16. A loudspeaker unit according to claim 1, in which the resonant panel loudspeaker functions as a diffuse dipole acoustic source.

17. A loudspeaker unit according to claim 16, in which the resonant panel loudspeaker provides diffuse surround sound reproduction.

18. A loudspeaker unit according to claim 16, in which a null of the dipole is substantially coincident with the axis along which the diaphragm is pistonically driven.

19. A loudspeaker unit according to claim 17, in which a null of the dipole is substantially coincident with the axis along which the diaphragm is pistonically driven.

20. A loudspeaker unit according to claim 1, in which the pistonically driven diaphragm loudspeaker functions as a monopole acoustic source.

21. A loudspeaker unit according to claim 1, further comprising an enclosure in which the resonant panel loudspeaker and the pistonically driven diaphragm loudspeaker are housed.

22. A loudspeaker unit according to claim 21, in which the enclosure comprises a first part housing the pistonically driven diaphragm loudspeaker and a second part housing the resonant panel loudspeaker.

23. A loudspeaker unit according to claim 22, in which the second part of the enclosure retains the resonant panel loudspeaker and is open on opposite major sides thereof adjacent to opposite major surfaces of the resonant panel loudspeaker, to allow acoustic radiation emitted by the resonant panel loudspeaker to propagate substantially freely from the loudspeaker unit.

24. A method of providing sound production, comprising the steps of:
selecting a loudspeaker unit including a pistonically driven diaphragm loudspeaker having a diaphragm, and a generally planar resonant panel loudspeaker, wherein the plane of the resonant panel loudspeaker lies generally in the same orientation as an axis along which the diaphragm is pistonically driven; and
utilizing the loudspeaker unit to provide both surround sound reproduction and imaged stereophonic sound reproduction simultaneously.

25. The method of claim 24, wherein the resonant panel loudspeaker provides the surround sound reproduction and the pistonically driven diaphragm loudspeaker provides the imaged stereophonic sound reproduction.

26. The method of claim 24, wherein the step of utilizing the loudspeaker unit includes the steps of using the loudspeaker unit as a part of an audio-visual system.

27. The method of claim 26, wherein the audio-visual system includes a visual display means, and the step of utilizing the loudspeaker unit includes situating the loudspeaker unit essentially adjacent to the visual display means.

28. The method of claim 27, wherein no additional surround sound loudspeakers are utilized.

29. The method of claim 27, further comprising the steps of:
selecting a second loudspeaker unit including a pistonically driven diaphragm loudspeaker having a diaphragm, and a generally planar resonant panel loudspeaker, wherein the plane of the resonant panel loudspeaker lies generally in the same orientation as an axis along which the diaphragm is pistonically driven; and
situating the second loudspeaker unit essentially adjacent to the visual display means.

30. The method of claim 29, in which no additional surround sound loudspeakers are utilized.

31. The method of claim 24, wherein the plane of the resonant panel loudspeaker lies substantially in the same orientation as an axis along which the diaphragm is pistonically driven.

32. The method of claim 31, wherein the axis along which the diaphragm is pistonically driven lies substantially in, or is substantially parallel to, the plane of the resonant panel loudspeaker.

33. The method of claim 24, wherein the resonant panel loudspeaker is located relative to the pistonically driven diaphragm loudspeaker such that emission of acoustic radiation from the diaphragm loudspeaker is substantially unimpeded by the resonant panel loudspeaker.

34. The method of claim 24, wherein the resonant panel loudspeaker is located to a side of the diaphragm loudspeaker.

35. The method of claim 24, wherein the resonant panel loudspeaker is located behind the diaphragm loudspeaker.

36. The method of claim 24, wherein the resonant panel loudspeaker includes a panel comprising two opposite major surfaces, and the resonant panel loudspeaker is arranged to radiate sound from both opposite major surfaces of the panel simultaneously.

37. The method of claim 24, wherein the resonant panel loudspeaker comprises a resonant panel and one or more exciters arranged to excite the panel.

38. The method of claim 37, wherein each exciter comprises a transducer.

39. The method of claim 24, wherein the resonant panel loudspeaker functions as a diffuse dipole acoustic source.

40. The method of claim 39, wherein the resonant panel loudspeaker provides diffuse surround sound reproduction.

41. The method of claim 40, wherein a null of the dipole is substantially coincident with the axis along which the diaphragm is pistonically driven.

42. The method of claim 40, wherein a null of the dipole is substantially coincident with the axis along which the diaphragm is pistonically driven.

43. The method of claim 24, wherein the pistonically driven diaphragm loudspeaker functions as a monopole acoustic source.

44. The method of claim 24, wherein the loudspeaker unit further comprises an enclosure in which the resonant panel loudspeaker and the pistonically driven diaphragm loudspeaker are housed.

45. The method of claim 44, wherein the enclosure comprises a first part housing the pistonically driven diaphragm loudspeaker and a second part housing the resonant panel loudspeaker.

46. The method of claim 45, wherein the second part of the enclosure retains the resonant panel loudspeaker and is open on opposite major sides thereof adjacent to opposite major surfaces of the resonant panel loudspeaker, to allow acoustic radiation emitted by the resonant panel loudspeaker to propagate substantially freely from the loudspeaker unit.

47. An audio-visual system comprising a visual display means and at least one loudspeaker unit including a pistonically driven diaphragm loudspeaker having a diaphragm, and a generally planar resonant panel loudspeaker, wherein the plane of the resonant panel loudspeaker lies generally in the same orientation as an axis along which the diaphragm is pistonically driven.

48. An audio-visual system of claim 47, in which the visual display means and the loudspeaker unit are combined in a single unit.

49. The audio-visual system of claim 47, wherein the plane of the resonant panel loudspeaker lies substantially in the same orientation as an axis along which the diaphragm is pistonically driven.

50. The audio-visual system of claim 49, wherein the axis along which the diaphragm is pistonically driven lies substantially in, or is substantially parallel to, the plane of the resonant panel loudspeaker.

51. The audio-visual system of claim 47, wherein the resonant panel loudspeaker is located relative to the pistonically driven diaphragm loudspeaker such that emission of acoustic radiation from the diaphragm loudspeaker is substantially unimpeded by the resonant panel loudspeaker.

52. The audio-visual system of claim 47, wherein the resonant panel loudspeaker is located to a side of the diaphragm loudspeaker.

53. The audio-visual system of claim 47, wherein the resonant panel loudspeaker is located behind the diaphragm loudspeaker.

54. The audio-visual system of claim 47, wherein the resonant panel loudspeaker includes a panel comprising two opposite major surfaces, and the resonant panel loudspeaker is arranged to radiate sound from both opposite major surfaces of the panel simultaneously.

55. The audio-visual system of claim 47, wherein the resonant panel loudspeaker comprises a resonant panel and one or more exciters arranged to excite the panel.

56. The audio-visual system of claim 55, wherein each exciter comprises a transducer.

57. The audio-visual system of claim 47, wherein the resonant panel loudspeaker functions as a diffuse dipole acoustic source.

58. The audio-visual system of claim 57, wherein the resonant panel loudspeaker provides diffuse surround sound reproduction.

59. The audio-visual system of claim 58, wherein a null of the dipole is substantially coincident with the axis along which the diaphragm is pistonically driven.

60. The audio-visual system of claim 58, wherein a null of the dipole is substantially coincident with the axis along which the diaphragm is pistonically driven.

61. The audio-visual system of claim 47, wherein the pistonically driven diaphragm loudspeaker functions as a monopole acoustic source.

62. The audio-visual system of claim 47, wherein the loudspeaker unit further comprises an enclosure in which the resonant panel loudspeaker and the pistonically driven diaphragm loudspeaker are housed.

63. The audio-visual system of claim 62, wherein the enclosure comprises a first part housing the pistonically driven diaphragm loudspeaker and a second part housing the resonant panel loudspeaker.

64. The audio-visual system of claim 63, wherein the second part of the enclosure retains the resonant panel loudspeaker and is open on opposite major sides thereof adjacent to opposite major surfaces of the resonant panel loudspeaker, to allow acoustic radiation emitted by the resonant panel loudspeaker to propagate substantially freely from the loudspeaker unit.
